(19) United States
(12) Patent Application Publication
(10) Pub. No.: US 2025/0292137 A1
(43) Pub. Date: Sep. 18, 2025

(54) HYBRID QUANTUM-CLASSICAL SYSTEM FOR ENHANCED COMBINATORIAL OPTIMIZATION

(71) Applicant: NVIDIA CORPORATION, Santa Clara, CA (US)

(72) Inventors: Hossein SEIFOORY, Toronto, Ontario (CA); Elad MENTOVICH, Tel Aviv (IL)

(73) Assignee: NVIDIA CORPORATION, Santa Clara, CA (US)

(21) Appl. No.: 18/602,246

(22) Filed: Mar. 12, 2024

(51) Int. Cl. G06N 10/60

(52) U.S. Cl. CPC G06N 10/60

(57) ABSTRACT

Systems, computer program products, and methods are described for a hybrid quantum-classical system for enhanced combinatorial optimization. An example system segments a received task into multiple sub-tasks. For each sub-task, the system accesses a database of pre-computed solutions through the classical computing unit to identify a suitable pre-computed solution. In scenarios where a pre-computed solution is not available for a sub-task, the classical computing unit transmits this sub-task to a quantum computing unit. The computing unit, utilizing a quantum optimization algorithm, computes a solution for the sub-task. This solution is then relayed back to the classical computing unit. The classical computing unit then implements each identified pre-computed and newly computed solution on the combinatorial optimization task.

### TECHNOLOGICAL FIELD

Example embodiments of the present invention relate to a hybrid quantum-classical system for enhanced combinatorial optimization.

### BACKGROUND

The Max-Cut problem, a fundamental challenge in combinatorial optimization, involves partitioning the vertices of an undirected graph into two sets, maximizing the number of edges between them. Traditional approaches to solving the Max-Cut problem often struggle with computational complexity, especially for large graphs. Quantum computing offers a new paradigm for tackling such problems, particularly through the Quantum Approximate Optimization Algorithm (QAOA). QAOA, designed for combinatorial optimization, encodes the problem into a quantum state and iteratively adjusts parameters to find an approximate solution. However, implementing QAOA effectively requires addressing some inherent limitations of current quantum computing technology.

Applicant has identified a number of deficiencies and problems associated with conventional quantum computations in combinatorial optimization tasks. Many of these identified problems have been solved by developing solutions that are included in embodiments of the present disclosure, many examples of which are described in detail herein.

### BRIEF SUMMARY

Systems, methods, and computer program products are therefore provided for hybrid quantum-classical system for enhanced combinatorial optimization.

In one aspect, a method for enhanced combinatorial optimization is presented. The method comprising: receiving, at a classical computing unit, a combinatorial optimization task; segmenting, using the classical computing unit, the combinatorial optimization task into a plurality of sub-tasks; for each sub-task, accessing, using the classical computing unit, a database of pre-computed solutions to identify a pre-computed solution for the sub-task and, in an instance in which the pre-computed solution is not identified for the sub-task, transmitting the sub-task from the classical computing unit to a quantum computing unit; computing, using the quantum computing unit, a solution for the sub-task using a quantum optimization algorithm; and transmitting the computed solution for the sub-task from the quantum computing unit to the classical computing unit; and implementing, using the classical computing unit, each pre-computed and computed solution on the combinatorial optimization task.

In some embodiments, the method further comprises: storing, using the classical computing unit, the computed solution in the database.

In some embodiments, the method further comprises, in an instance in which the pre-computed solution is identified for the sub-task: retrieving, using the classical computing unit, the pre-computed solution from the database.

In some embodiments, implementing, using the classical computing unit, each pre-computed and computed solution on the combinatorial optimization task comprises: aggregating, using the classical computing unit, the pre-computed solution and the computed solution for each sub-task to generate a solution for the combinatorial optimization task; and implementing, using the classical computing unit, the solution on the combinatorial optimization task.

In some embodiments, the method further comprises, for each sub-task, in an instance in which the pre-computed solution for the sub-task is not identified: accessing, using the classical computing unit, an alternate pre-computed solution, wherein the alternate pre-computed solution is a pre-computed solution for an alternate sub-task having similar structure as the sub-task, wherein implementing, using the classical computing unit, each pre-computed and computed solution on the combinatorial optimization task comprises implementing each alternate pre-computed solution on the combinatorial optimization task.

In some embodiments, the combinatorial optimization task is a graph associated with a Max-Cut problem, and wherein each sub-task is a sub-graph.

In some embodiments, each pre-computed solution and computed solution is computed using an optimization algorithm.

In some embodiments, the optimization algorithm is a Quantum Approximate Optimization Algorithm (QAOA).

In another aspect, a system for enhanced combinatorial optimization is presented. The system comprising: a classical computing unit, the classical computing unit comprising: a processing device; and a non-transitory storage device containing instructions that, when executed by the processing device, cause the processing device to: receive, from a computing device of a user, a combinatorial optimization task; segment the combinatorial optimization task into a plurality of sub-tasks; and for each sub-task, access a database of pre-computed solutions to identify a pre-computed solution for the sub-task; and a quantum computing unit operatively coupled to the classical computing unit, wherein, in an instance in which the pre-computed solution is not identified for the sub-task, the classical computing unit is configured to transmit the sub-task to the quantum computing unit for processing and the quantum computing unit is configured to: compute a solution for the sub-task using a quantum optimization algorithm; and transmit the computed solution to the classical computing unit, and wherein the instructions, when executed by the processing device, cause the processing device to implement each pre-computed and computed solution on the combinatorial optimization task.

In yet another aspect, a computer program product for enhanced combinatorial optimization is presented. The computer program product comprising a non-transitory computer-readable medium comprising code configured to cause an apparatus to: receive, at a classical computing unit, a combinatorial optimization task; segment, using the classical computing unit, the combinatorial optimization task into a plurality of sub-tasks; for each sub-task, access, using the classical computing unit, a database of pre-computed solutions to identify a pre-computed solution for the sub-task and, in an instance in which the pre-computed solution is not identified for the sub-task, transmitting the sub-task from the classical computing unit to a quantum computing unit; computing, using the quantum computing unit, a solution for the sub-task using a quantum optimization algorithm; and transmitting the computed solution for the sub-task from the quantum computing unit to the classical computing unit; and implement, using the classical computing unit, each pre-computed and computed solution on the combinatorial optimization task.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIGS. 1A-1C illustrate an example system environment for enhanced combinatorial optimization using a hybrid quantum-classical system, in accordance with an embodiment of the present invention; and

FIG. 2 illustrates an example method for enhanced combinatorial optimization using a hybrid quantum-classical system, in accordance with an embodiment of the invention.

### DETAILED DESCRIPTION

### Overview

The advent of quantum computing represents a significant leap in computational capabilities, leveraging the principles of quantum mechanics to perform complex calculations with remarkable speed. This novel computing paradigm is distinguished by its potential to resolve specific problems much more efficiently than classical computers. Currently, the field is primarily focused on the development and refinement of quantum algorithms suitable for the existing generation of quantum computers, referred to as Noisy Intermediate-Scale Quantum (NISQ) devices. These NISQ devices are currently in a developmental stage, characterized by a limited number of qubits and a susceptibility to errors, primarily due to environmental interference and hardware imperfections.

Despite these challenges, NISQ computers are a promising avenue for tackling problem domains that are beyond the reach of classical computing methods. They are particularly adept at addressing issues in quantum chemistry and certain optimization tasks, which are otherwise computationally demanding or infeasible for traditional computing systems. The unique attributes of quantum computing, such as superposition and entanglement, enable NISQ machines to analyze and process information in ways unattainable by classical computers, opening new frontiers in computational science and technology.

Variational Quantum Algorithms (VQA) are a pivotal class of algorithms within the realm of quantum computing, specifically designed to maximize the potential of NISQ devices. These algorithms utilize the variational principle, a fundamental concept in quantum theory, to tackle a broad spectrum of computational tasks. Central to the operation of VQA is the objective of determining the minimal expectation value of certain observables, often associated with the complexities of quantum systems. A typical example includes the Hamiltonians that define the energy states of molecular structures.

The compatibility of VQA with NISQ devices stems from their inherent adaptability and iterative methodology. These algorithms make use of parametric quantum circuits, which are distinguished by their tunable parameters. This characteristic permits quantum computers to progressively refine outcomes through iterations. Such an approach is particularly advantageous given the susceptibility of NISQ devices to noise and hardware imperfections. By adapting to these constraints, VQA emerges as an instrument in addressing real-world problems across various domains, including quantum chemistry, optimization, and machine learning.

Within the domain of VQA, the Quantum Approximate Optimization Algorithm (QAOA) is specifically designed to tackle complex optimization challenges, such as the Traveling Salesman Problem or Max-Cut, by employing qubits, the fundamental units of quantum information. QAOA encodes the given optimization problem into a quantum circuit, which is then manipulated using a sequence of quantum gates that act on the qubits. An important aspect of QAOA is its iterative nature, pursuant to which parameters are continuously adjusted to enhance the quality of the solution obtained. While QAOA does not necessarily guarantee optimal results, it signifies a substantial stride in utilizing quantum computing for practical problem-solving across various sectors, including logistics, materials science, machine learning, and/or the like.

While QAOA presents a significant advancement in quantum computing, its practical application is hindered by the current limitations in quantum resources, particularly the constraints imposed by the available quantum hardware. One of the primary challenges is the limited number of qubits in existing quantum systems, which directly restricts the scale and complexity of the problems that QAOA can address effectively. This limitation becomes particularly pronounced when dealing with large-scale problems. In response to this challenge, the adoption of a distributed quantum computing architecture has been proposed as a viable solution. This architecture envisions a network of interconnected quantum computers, working in tandem to enhance the overall scalability and processing power of the system. In such a distributed setup, large-scale problems would be divided into smaller, more manageable segments. Each segment would be processed individually within the resource limitations of a single quantum processor. Upon completion of these individual computations, the partial solutions would then be collated and analyzed using advanced post-processing techniques to synthesize the final solution for the entire problem. This method of decomposition and aggregation helps maximize the utility of a distributed quantum computing infrastructure.

In the evolving landscape of quantum computing, QAOA has been subject to various innovative implementations aimed at enhancing its performance and expanding its problem-solving capabilities. Notable among these are the multi-angle QAOA (ma-QAOA) and the divide-and-conquer QAOA (DC-QAOA). Each of these implementations introduces modifications to the standard QAOA framework, tailoring it to address specific challenges or to improve efficiency in solving complex problems.

Embodiments of the invention focus on a specialized application of DC-QAOA, particularly in addressing the Max-Cut problem. The Max-Cut problem, a fundamental challenge in combinatorial optimization, involves partitioning the vertices of an undirected graph into two sets, maximizing the number of edges between them. Traditional approaches to solving the Max-Cut problem often struggle with computational complexity, especially for large graphs. QAOA, designed for combinatorial optimization, encodes the problem into a quantum state and iteratively adjusts parameters to find an approximate solution. However, implementing QAOA effectively requires addressing some inherent limitations of current quantum computing technology.

Current quantum computers, characterized by limited quantum resources such as a small number of qubits, face significant challenges in directly solving large-scale Max-Cut problems using QAOA. This limitation is compounded by the need for multiple, often costly, runs on quantum resources, particularly in complex or large-scale instances. Furthermore, the computational burden increases when considering variations like the divide-and-conquer QAOA, which requires processing numerous subgraphs.

To overcome these challenges, embodiments of the invention introduce a novel approach that uses a precomputed graph database alongside continuous learning of new graph patterns. The process starts by dividing a large graph into smaller subgraphs using a divide-and-conquer method. Each subgraph is then checked against the database for a precomputed QAOA solution. If such a solution is unavailable, the process searches for isomorphic forms of the subgraph in the database, leveraging the structural similarities to map existing solutions to new problems. When neither the subgraph nor its isomorphic forms are found, the subgraph is assigned to an external processor (e.g., quantum computing unit, other high performance classical computing units, and/or the like) for QAOA processing. This approach not only records each new solution in the database for future use but also utilizes the computational power of multiple GPUs for parallel processing. In doing so, the process significantly reduces the number of runs on quantum resources, optimizing efficiency and making large-scale Max-Cut problem-solving more feasible.

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, “quantum computing unit” may refer to quantum simulation units that emulate quantum behavior on classical hardware, specialized quantum annealers designed for optimization problems, and other types of quantum processors including gate-based quantum computers which use quantum gates to perform operations, and topological quantum computers that leverage anyonic systems for quantum computation. In general, “quantum computing unit” may include devices capable of exploiting quantum mechanical phenomena such as superposition and entanglement to perform calculations.

As used herein, “operatively coupled” may mean that the components are electronically or optically coupled and/or are in electrical or optical communication with one another. Furthermore, “operatively coupled” may mean that the components may be formed integrally with each other or may be formed separately and coupled together. Furthermore, “operatively coupled” may mean that the components may be directly connected to each other or may be connected to each other with one or more components (e.g., connectors) located between the components that are operatively coupled together. Furthermore, “operatively coupled” may mean that the components are detachable from each other or that they are permanently coupled together.

As used herein, “interconnected” may imply that each component is directly or indirectly linked to every other component or switch in the network, allowing for seamless data transfer and communication between all the components.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

It should be understood that the word “exemplary” is used herein to mean “serving as an example, instance, or illustration.” Any implementation described herein as “exemplary” is not necessarily to be construed as advantageous over other implementations.

Furthermore, as would be evident to one of ordinary skill in the art in light of the present disclosure, the terms “substantially” and “approximately” indicate that the referenced element or associated description is accurate to within applicable engineering tolerances.

### Example System Environment

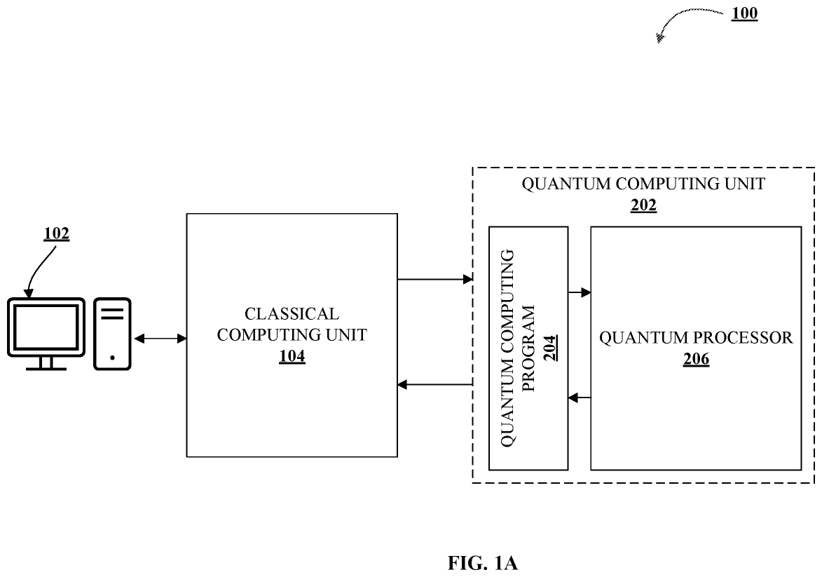

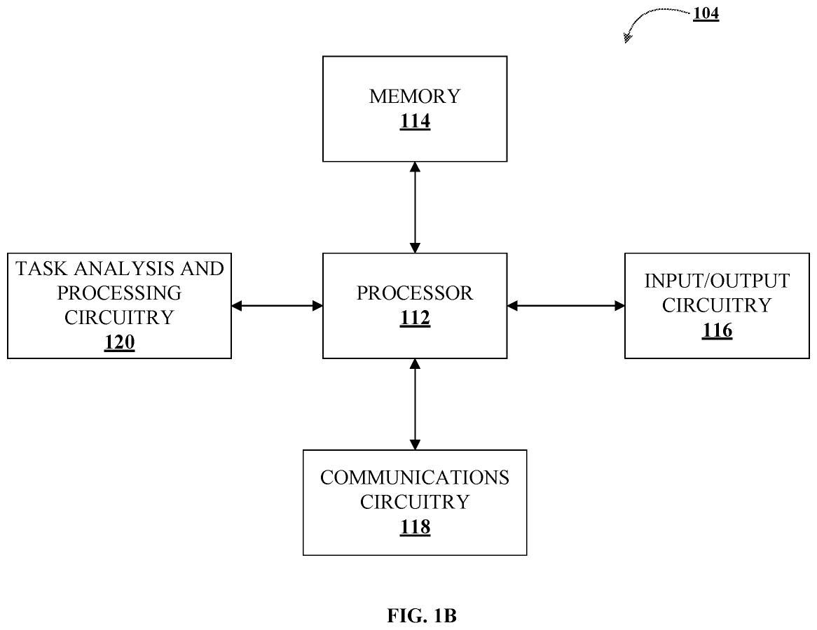

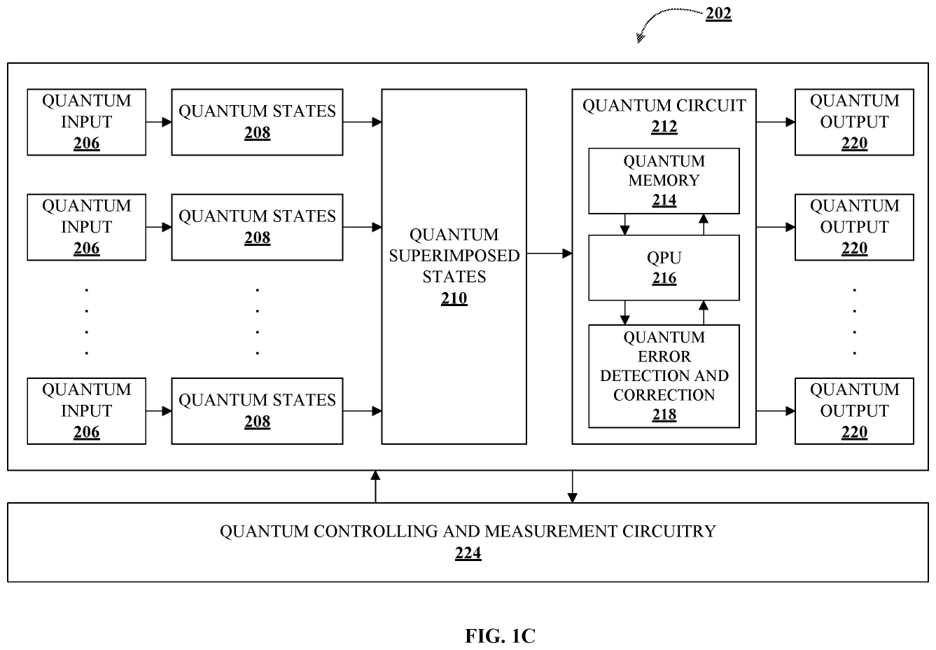

FIGS. 1A-1C illustrate an example system environment 100 for enhanced combinatorial optimization using a hybrid quantum-classical system, in accordance with an embodiment of the present invention. As shown in FIG. 1A, the system environment 100 may include a computing device 102, a classical computing unit 104, and a quantum computing unit 202. FIG. 1A illustrates only one example of an embodiment of the system environment 100, and it will be appreciated that in other embodiments one or more of the systems, units, devices, and/or servers may be combined into a single system, unit, device, or server, or be made up of multiple systems, devices, or servers. Also, the system environment 100 may include multiple units, same or similar to unit 104, with each unit providing portions of the necessary operations.

A computing device 102 may encompass a diverse range of electronic devices characterized by their capacity for data processing and connectivity. As such, a computing device 102 may include personal digital assistants, which offer compact computing functionalities; cellular telephones and smartphones, which provide voice and data communication capabilities; and computing devices such as laptops and desktops, known for their versatile computing power and user interface options. Additionally, the scope of computing devices may extend to edge devices, exemplified by routers and routing switches used to direct data traffic, and integrated access devices (IADs), which facilitate access to various communication services.

A classical computing unit 104, as described in more detail in FIG. 1B, may encompass a broad range of electronic devices designed to perform computations based on classical mechanics principles. Such units may be characterized by their ability to execute algorithms through the manipulation of binary data, commonly represented as bits. Each bit in a classical computing unit 104 may assume a definite state, either 0 or 1, enabling the representation and processing of information. The classical computing unit 104 may be implemented in a number of different forms. For example, the classical computing unit 104 may be implemented as a standard server, or multiple times in a group of such servers. Additionally, the classical computing unit 104 may also be implemented as part of a rack server system or a personal computer such as a laptop computer. Alternatively, components from the classical computing unit 104 may be combined with one or more other same or similar units, and an entire unit may be made up of multiple computing devices communicating with each other. The classical computing unit 104 may represent various forms of servers, such as web servers, database servers, file servers, or the like, various forms of digital computing devices, such as laptops, desktops, workstations, or the like, or any other auxiliary network devices, Internet-of-things devices, mainframes, or the like, or any combination of the aforementioned.

A quantum computing unit 202, as described in more detail in FIG. 1C, may operate on quantum bits, or qubits, employing the principles of quantum mechanics. A qubit, in its fundamental nature, harnesses the phenomena of superposition and entanglement, allowing it to exist in multiple states simultaneously, rather than being limited to a binary state of 0 or 1. This attribute permits the quantum computing unit 202 to perform complex calculations at a significantly accelerated rate compared to its classical counterparts (e.g., classical computing unit 102). The quantum computing unit 202 may be implemented in various configurations to suit differing computational needs and environments. For instance, the quantum computing unit 202 may be implemented as a dedicated quantum server, which could be singular or replicated across multiple units within a server cluster. Furthermore, the quantum computing unit 202 may be part of a more complex unit, such as a quantum-enabled rack server setup, or integrated within advanced computing systems, including high-performance workstations specifically designed for quantum computations. In certain embodiments, components from the quantum computing unit 202 may be configured to operate in conjunction with similar units, forming a cohesive quantum computing network. This network can be composed of multiple quantum computing devices, each communicating and collaborating to perform complex quantum computations. The quantum computing unit 202, in its diverse forms, may represent specialized servers such as quantum database servers, quantum simulation servers, or other server types optimized for specific quantum computing tasks.

Additionally, the quantum computing unit 202 may take the form of various digital quantum devices, ranging from quantum-enhanced desktops to sophisticated quantum workstations, each designed to leverage the unique properties of quantum computing. The quantum computing unit 202 may also take the form of auxiliary network devices and Internet-of-Things (IoT) devices that are quantum-capable, thereby enhancing their computational capabilities. In more extensive and demanding computational scenarios, the quantum computing unit 202 could be implemented in mainframe systems, offering large-scale quantum processing power.

In some embodiments, the classical computing unit 104 may be configured to serve as an intermediary that manages the execution of tasks. In this regard, upon receiving an input indicative of a task, such as a combinatorial optimization task (COT), the classical computing unit 104 may assess the nature of the task to determine the optimal division of computational labor between itself and the quantum computing unit 202. For portions of the task that are well-suited to classical computation, the classical computing unit 104 may retain responsibility, leveraging its deterministic processing capabilities. Conversely, for components of the task that may benefit from the probabilistic and parallel processing advantages of quantum mechanics, the classical computing unit 104 may delegate these components to the quantum computing unit 202. This delegation may be facilitated through the quantum computing program 204.

The quantum computing program 204 may be an intermediary framework that facilitates communication and operation between the classical computing unit 104 and the quantum computing unit 202. The primary objective of the quantum computing program 204 may be to translate classical computation requirements into quantum computing operations and interpret the results from the quantum realm back into a classical context. In this regard, in some embodiments, the quantum computing program 204 may decompose classical problems into quantum circuits or algorithms, thereby generating quantum input that is understandable in terms of quantum gates and measurements. In specific embodiments, this may involve initializing a series of qubits in a defined state, typically the ground state |0 [symbol] . The quantum computing program 204 may then apply a series of unitary transformations to these qubits, corresponding to quantum gates, which evolve their states from the classical binary representation to a quantum state that captures the essence of the combinatorial optimization task. In doing so, the quantum computing program 204 may create superpositions where qubits are placed in a state that represents multiple possibilities simultaneously, enabling the quantum computing unit 202 to process a vast amount of data in parallel through quantum parallelism. In some embodiments, the quantum computing program 204 may ensure that the sequence of gates applied may be optimized to represent the problem within the constraints of the quantum hardware, often involving the use of specific quantum algorithms that are best suited for the architecture of the quantum processor. Once the qubits are in the correct quantum states, representing the quantum input, the quantum computing unit 202 can proceed with further computations. After computation, the quantum computing program 204 may also interpret the resulting quantum states, which may still be in superposition, and translate them back into classical information by measuring the states of the qubits. This measurement collapses the superposition into a definite state, from which classical data can be extracted.

In some embodiments, the computing device 102, the classical computing unit 104 and the quantum computing unit 202 may communicate via a network (not shown). The network may include a distributed network architecture that spans a variety of network types, facilitating a cohesive data communication network that can be managed jointly or individually. The network architecture may support shared communication as well as distributed processing across platforms such as telecommunication networks, local area networks (LAN), wide area networks (WAN), global area networks (GAN), the Internet infrastructure, and/or the like. The network may also integrate emerging networking technologies, including software-defined networking (SDN), network function virtualization (NFV), and next-generation wireless communication standards like 5G. The network may employ secure or unsecure, as well as wireless, wired, and optical interconnection technologies, and/or the like, to accommodate a spectrum of communication and processing needs.

It is to be understood that the structure of the system environment 100 and its components, connections and relationships, and their functions, are meant to be exemplary only, and are not meant to limit implementations of the disclosures described and/or claimed in this document. In one example, the system environment 100 may include more, fewer, or different components. In another example, some or all of the portions of the system environment 100 may be combined into a single portion or all of the portions of the environment 100 may be separated into two or more distinct portions.

### Example Classical Computing Unit Circuitry

FIG. 1B illustrates a schematic block diagram of example circuitry, some or all of which may be included in the classical computing unit 104. As shown in FIG. 1B, the classical computing unit 104 may include a processor 112, a memory 114, input/output circuitry 116, communications circuitry 118, and task analysis and processing circuitry 120.

Although the term “circuitry” as used herein with respect to components 112-120 is described in some cases using functional language, it should be understood that the particular implementations necessarily include the use of particular hardware configured to perform the functions associated with the respective circuitry as described herein. It should also be understood that certain of these components 112-120 may include similar or common hardware. For example, two sets of circuitries may both leverage use of the same processor, network interface, storage medium, or the like to perform their associated functions, such that duplicate hardware is not required for each set of circuitries. It will be understood in this regard that some of the components described in connection with the classical computing unit 104 may be housed together, while other components are housed separately (e.g., a controller in communication with the classical computing unit 104). While the term “circuitry” should be understood broadly to include hardware, in some embodiments, the term “circuitry” may also include software for configuring the hardware. For example, in some embodiments, “circuitry” may include processing circuitry, storage media, network interfaces, input/output devices, and the like. In some embodiments, other elements of the classical computing unit 104 may provide or supplement the functionality of particular circuitry. For example, the processor 112 may provide processing functionality, the memory 114 may provide storage functionality, the communications circuitry 118 may provide network interface functionality, and the like.

In some embodiments, the processor 112 (and/or co-processor or any other processing circuitry assisting or otherwise associated with the processor) may be in communication with the memory 114 via a bus for passing information among components of, for example, the classical computing unit 104. The memory 114 may be non-transitory and may include, for example, one or more volatile and/or non-volatile memories, or some combination thereof. In other words, for example, the memory 114 may be an electronic storage device (e.g., a non-transitory computer readable storage medium). The memory 114 may be configured to store information, data, content, applications, instructions, or the like, for enabling an apparatus, e.g., the classical computing unit 104, to carry out various functions in accordance with example embodiments of the present disclosure.

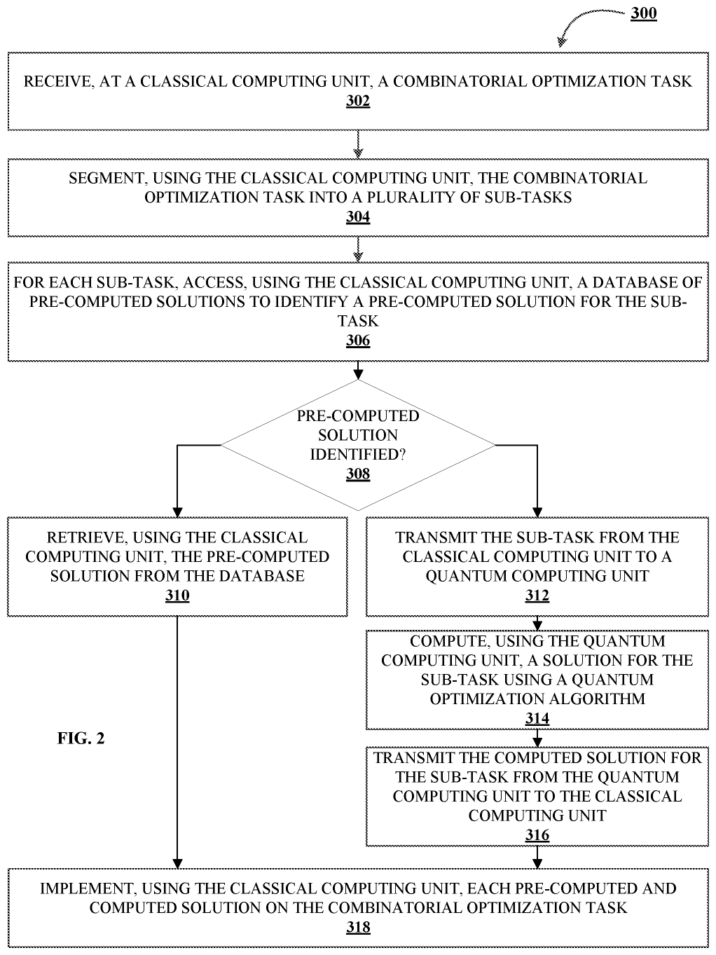

Although illustrated in FIG. 2 as a single memory, the memory 114 may comprise a plurality of memory components. The plurality of memory components may be embodied on a single computing device or distributed across a plurality of computing devices. In various embodiments, the memory 114 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 114 may be configured to store information, data, applications, instructions, or the like for enabling the classical computing unit 104 to carry out various functions in accordance with example embodiments discussed herein. For example, in at least some embodiments, the memory 114 may be configured to buffer data for processing by the processor 112. Additionally, or alternatively, in at least some embodiments, the memory 114 may be configured to store program instructions for execution by the processor 112. The memory 114 may store information in the form of static and/or dynamic information. This stored information may be stored and/or used by the classical computing unit 104 during the course of performing its functionalities.

The processor 112 may be embodied in a number of different ways and may, for example, include one or more processing devices configured to perform independently. Additionally, or alternatively, the processor 112 may include one or more processors configured in tandem via a bus to enable independent execution of instructions, pipelining, and/or multithreading. The processor 112 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 2 as a single processor, in some embodiments, the processor 112 may include a plurality of processors. The plurality of processors may be embodied on a single computing device or may be distributed across a plurality of such devices collectively configured to function as the classical computing unit 104. The plurality of processors may be in operative communication with each other and may be collectively configured to perform one or more functionalities of the classical computing unit 104 as described herein.

In an example embodiment, the processor 112 may be configured to execute instructions stored in the memory 114 or otherwise accessible to the processor 112. Alternatively, or additionally, the processor 112 may be configured to execute hard-coded functionality. As such, whether configured by hardware or software methods, or by a combination thereof, the processor 112 may represent an entity (e.g., physically embodied in circuitry) capable of performing operations according to an embodiment of the present disclosure while configured accordingly. Alternatively, as another example, when the processor 112 is embodied as an executor of software instructions, the instructions may specifically configure the processor 112 to perform one or more algorithms and/or operations described herein when the instructions are executed. For example, these instructions, when executed by the processor 112, may cause the classical computing unit 104 to perform one or more of the functionalities thereof as described herein.

In some embodiments, the classical computing unit 104 further includes input/output circuitry 116 that may, in turn, be in communication with the processor 112 to provide an audible, visual, mechanical, or other output and/or, in some embodiments, to receive an indication of an input from a user or another source. In that sense, the input/output circuitry 116 may include means for performing analog-to-digital and/or digital-to-analog data conversions. The input/output circuitry 116 may include support, for example, for a display, touchscreen, keyboard, mouse, image capturing device (e.g., a camera), microphone, and/or other input/output mechanisms. The input/output circuitry 116 may include a user interface and may include a web user interface, a mobile application, a kiosk, or the like. The input/output circuitry 116 may interface with the quantum computing unit 204 to transmit sub-tasks to, and receive corresponding solutions for sub-tasks from, the quantum computing unit 204. These solutions are then transmitted to one or more other components (e.g., the processor 112) for further action.

The processor 112 and/or user interface circuitry comprising the processor 112 may be configured to control one or more functions of a display or one or more user interface elements through computer-program instructions (e.g., software and/or firmware) stored on a memory accessible to the processor 112 (e.g., the memory 114, and/or the like). In some embodiments, aspects of input/output circuitry 116 may be reduced as compared to embodiments where the classical computing unit 104 may be implemented as an end-user machine or other type of device designed for complex user interactions. In some embodiments (like other components discussed herein), the input/output circuitry 116 may be eliminated from the classical computing unit 104. The input/output circuitry 116 may be in communication with memory 114, communications circuitry 118, and/or any other component(s), such as via a bus. Although more than one input/output circuitry and/or other component can be included in the classical computing unit 104, only one is shown in FIG. 2 to avoid overcomplicating the disclosure (e.g., as with the other components discussed herein).

The communications circuitry 118, in some embodiments, includes any means, such as a device or circuitry embodied in either hardware, software, firmware or a combination of hardware, software, and/or firmware, that is configured to receive and/or transmit data from/to a network and/or any other device, circuitry, or module associated therewith. In this regard, the communications circuitry 118 may include, for example, a network interface for enabling communications with a wired or wireless communication network. For example, in some embodiments, communications circuitry 118 may be configured to receive and/or transmit any data that may be stored by the memory 114 using any protocol that may be used for communications between computing devices. For example, the communications circuitry 118 may include one or more network interface cards, antennae, transmitters, receivers, buses, switches, routers, modems, and supporting hardware and/or software, and/or firmware/software, or any other device suitable for enabling communications via a network. Additionally, or alternatively, in some embodiments, the communications circuitry 118 may include circuitry for interacting with the antenna(s) to cause transmission of signals via the antenna(e) or to handle receipt of signals received via the antenna(e). These signals may be transmitted by the classical computing unit 104 using any of a number of wireless personal area network (PAN) technologies, such as Bluetooth® v1.0 through v5.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. The communications circuitry 118 may additionally or alternatively be in communication with the memory 114, the input/output circuitry 116, and/or any other component of the classical computing unit 104, such as via a bus. The communication circuitry 118 of the classical computing unit 104 may also be configured to receive and transmit information with the various components associated therewith. The communication circuitry 118 may be configured to communicate with the quantum computing unit 204 to transmit sub-tasks to, and receive corresponding solutions for sub-tasks from, the quantum computing unit 204.

The task analysis and processing circuitry 120, in some embodiments, may be used to facilitate execution of the combinatorial optimization task, such as a Max-Cut problem. In this regard, the task analysis and processing circuitry 120 may be configured to implement a divide-and-conquer based approach to the combinatorial optimization task and divide the task into multiple sub-tasks. Once the task is segmented, the task analysis and processing circuitry 120 may proceed to access a database (e.g., a database stored in the memory 114 or in a separate memory that is accessible by the classical computing unit 104 via the communications circuitry 116) containing a variety of pre-computed solutions for different sub-tasks. For each segmented sub-task, the task analysis and processing circuitry 120 may be configured to identify a matching pre-computed solution within this database. If a suitable pre-computed solution is found, the task analysis and processing circuitry 120 may transmit control signals to the processor 112 to directly apply the pre-computed solution on the sub-task in question. In cases where a pre-computed solution is not available for a specific sub-task, the task analysis and processing circuitry 120 may transmit control signals to the processor 112 to transfer the sub-task to a quantum computing unit (e.g., quantum computing unit 204 in FIG. 1A and 1C). This quantum computing unit, employing quantum optimization algorithms, may compute a solution for the sub-task. Upon the completion of the quantum computation process and the derivation of a solution for the sub-task, the quantum computing unit may transmit this solution back to the classical computing unit 104, for example, via the communications circuitry 118. The task analysis and processing circuitry 120 may be configured to integrate these quantum-computed solutions with any pre-computed solutions previously applied. This integration process may be carried out for all sub-tasks, culminating in a comprehensive solution for the initial combinatorial optimization task.

In some embodiments, the classical computing unit 104 may include hardware, software, firmware, and/or a combination of such components, configured to support various aspects of combinatorial optimization as described herein. It should be appreciated that in some embodiments, the task analysis and processing circuitry 120 may perform one or more of such example actions in combination with another circuitry of the classical computing unit 104, such as the memory 114, processor 112, input/output circuitry 116, and communications circuitry 118. For example, in some embodiments, the task analysis and processing circuitry 120 utilizes processing circuitry, such as the processor 112 and/or the like, to form a self-contained subsystem to perform one or more of its corresponding operations. In a further example, and in some embodiments, some or all of the functionality of the task analysis and processing circuitry 120 may be performed by the processor 112. In this regard, some or all of the example processes and algorithms discussed herein can be performed by at least one processor 112 and/or the task analysis and processing circuitry 120. It should also be appreciated that, in some embodiments, the task analysis and processing circuitry 120 may include a separate processor, specially configured FPGA, or ASIC to perform its corresponding functions.

Additionally, or alternatively, in some embodiments, the task analysis and processing circuitry 120 may use the memory 114 to store collected information. For example, in some implementations, the task analysis and processing circuitry 120 may include hardware, software, firmware, and/or a combination thereof, that interacts with the memory 114 to send, retrieve, update, and/or store data.

Accordingly, non-transitory computer readable storage media, which may, for example, be the memory 114, can be configured to store firmware, one or more application programs, and/or other software, which include instructions and/or other computer-readable program code portions that can be executed to direct operation of the classical computing unit 104 to implement various operations, including the examples described herein. As such, a series of computer-readable program code portions may be embodied in one or more computer-program products and can be used, with a device, classical computing unit 104, database, and/or other programmable apparatus, to produce the machine-implemented processes discussed herein. It is also noted that all or some of the information discussed herein can be based on data that is received, generated and/or maintained by one or more components of the classical computing unit 104. In some embodiments, one or more external systems (such as a remote cloud computing and/or data storage system) may also be leveraged to provide at least some of the functionality discussed herein.

### Example Quantum Computing Unit Circuitry

FIG. 1C illustrates a schematic block diagram of example circuitry, some or all of which may be included in the quantum computing unit 202. As shown in FIG. 1C, the quantum computing unit 202 may include quantum inputs 206, quantum states 208, quantum superimposed states 210, a quantum circuit 212, quantum outputs 220, and quantum controlling and measurement circuitry 224. The quantum circuit 212 may further include quantum memory 214, quantum central processing unit (CPU) 216 and quantum error detection and correction circuitry 218.

The quantum input 206 may refer to the initial data or signals (e.g., associated with the combinatorial optimization task) that are encoded into qubits prior to their entry into a quantum computing unit 202. As described herein, the quantum computing program (e.g., quantum computing program 204 in FIG. 1A), may interpret classical computation requirements by translating them into quantum input 206 that can be executed within the quantum computing unit 202. These quantum inputs 206 may be the quantum equivalent of classical binary information but are represented in quantum mechanical properties of particles, such as the polarization of photons or the spin of electrons.

The quantum state 208 may refer to the particular condition or configuration of a qubit, which can represent a_0, a_1, or any quantum superposition of these binary states. Once the classical data is translated into the language of quantum mechanics, the corresponding qubits are initialized into specific quantum states 208. These quantum states 208 may be direct representation of the quantum inputs and serve as the starting point for the quantum computation. Each quantum state 208 may be described by a unique vector in a Hilbert space, and the collective set of these vectors forms the basis for the quantum computing unit's 202 computational capabilities. The quantum states 208 may be manipulated by quantum gates to perform computations.

Superposition is an inherent property of quantum mechanics that allows a qubit to exist in a linear combination of the basis states |0 [symbol] and |1 [symbol] ). When a qubit is in superposition, it is said to be in a quantum superimposed state 210, where the qubit simultaneously holds the possibility of being in multiple states until a measurement is made. In some embodiments, each qubit state may be transformed into a superimposed state using quantum gates, such as the Hadamard gate, enabling the representation of multiple classical states within a single quantum state. These superimposed states allow the quantum computing unit 202 to process a vast number of possible inputs in parallel. When quantum gates are applied to superimposed states, they may manipulate all the possible states at once, which increases processing speed for certain computational problems as compared to classical computing.

As noted above and shown in FIG. 1C, the quantum circuit 212 may include a quantum memory 214, a quantum processing unit (QPU) 216, and quantum error detection and correction circuitry 218. Quantum memory 214 may refer to a device or system that is capable of storing quantum information, which may be represented by quantum states, over a period of time. As described herein, the quantum information may be encoded in qubits or qutrits, the fundamental units of quantum information that generalize the classical binary bit to the quantum domain. In some embodiments, the quantum memory 214 may be composed of an array of quantum states, each potentially in a superposed configuration. The quantum memory 214 may be responsible for preserving the integrity of quantum states during computation and between operations. In this regard, the quantum memory 214 may employ quantum registers to preserve the state information of a quantum circuit. In complex quantum systems, the quantum memory 214 can synchronize operations by holding quantum states until they are needed, ensuring that different parts of the system can operate in harmony.

A QPU 216 may refer to a core computational engine of a quantum computer that is configured to perform the actual quantum calculations. The QPU 216 may operate using the principles of quantum mechanics, manipulating qubits or qutrits to perform computations that can be more powerful for certain tasks than those performed by classical CPUs. In some embodiments, quantum operations may be executed by applying a sequence of quantum gates, which are the building blocks of quantum circuits. These quantum gates may perform unitary operations on qubits, changing their state. In some embodiments, the QPU 216 may generate and manipulate entangled states, a fundamental quantum resource. Entanglement may refer to a phenomenon where qubits become interdependent, such that the state of one qubit instantaneously influences the state of another, regardless of the distance separating them. Due to superposition and entanglement, the QPU 216 can perform many calculations in parallel.

The quantum error detection and correction circuitry 218 may be configured to maintain the integrity of quantum information processing by employing an array of ancilla qubits, which may be specifically used for monitoring the integrity of the primary data qubits. In doing so, the quantum error detection and correction circuitry 218 may detect the quantum errors without directly interfering with the computational quantum states. Quantum error correction may be performed to protect the quantum information from the errors that occurred because of quantum noise and decoherence. The error in the quantum computing unit 202 can be identified by using ancilla qubits without disturbing the information in data qubits and may be characterized by alterations in the amplitude or phase of the qubits' quantum states.

The quantum output 220 may represent the final state of the quantum computing unit 202 following the execution of a series of quantum computational processes facilitated by the quantum circuit 212. As described herein, the quantum circuit 212, comprising an arrangement of quantum gates, may manipulate the quantum states of qubits through unitary operations, fundamentally altering their superposition and entanglement properties in a controlled manner to perform specific computations. Upon completion of these operations, the quantum circuit 212 may yield a quantum output 220, which is then subject to measurement processes (carried out by the quantum computing program 204). This measurement collapses the superposed and entangled states of the qubits into definitive classical states, thus converting the quantum information into classical output that can be interpreted and utilized.

The quantum controlling and measurement circuitry 224 may monitor the manipulation of quantum states 208 and the execution of quantum computations by the quantum circuit 212. In this regard, the quantum controlling and measurement circuitry 224 may detect errors resulting from quantum noise or operational faults and initiate appropriate corrective actions. In some embodiments, the quantum controlling and measurement circuitry 224 may be used in the final measurement of quantum states, which converts quantum data into classical information.

It is to be understood that the structure of the quantum computing unit 202 and its components described herein represents merely one embodiment of a myriad of possible configurations. The structure of the quantum computing unit showcases a specific arrangement and interaction of quantum elements—including qubits, quantum gates, and control mechanisms—that collectively facilitate quantum computation. However, this configuration is not limiting, and the structure of the quantum computing unit and its constituent components can vary to accommodate different quantum computing paradigms, physical implementations, and technological advancements. Alternative embodiments may utilize different types of qubits, such as superconducting circuits, trapped ions, or topological qubits, each with their own unique quantum gate structures and control methodologies. Furthermore, the scalability, error correction techniques, and quantum state readout mechanisms can differ significantly depending on the specific application and operational requirements. Consequently, while the present disclosure provides a comprehensive illustration of one potential quantum computing unit structure, it is to be understood that this is an exemplification of broader principles of quantum computing and should not be construed as a limitation on the scope of the invention, which is capable of being implemented in various other forms, technologies, and configurations.

### Example Method for Enhanced Combinatorial Optimization using a Hybrid Quantum-Classical System

FIG. 2 illustrates an example method 300 for enhanced combinatorial optimization using hybrid quantum-classical system, in accordance with an embodiment of the invention. As shown in block 302, the method may receive, at a classical computing unit, a combinatorial optimization task. The classical computing unit may, for example, be a classical computing unit 104 as shown in FIGS. 1A and 1B and described above. The combinatorial optimization task may refer to a problem in the field of optimization where the objective is to find an optimal solution from a finite set of discrete alternatives. Such a problem typically involves a set of items and a set of constraints, with the aim of either maximizing or minimizing a certain objective function. As described herein, the Max-Cut problem may be a combinatorial optimization task. In the Max-Cut problem, given an undirected graph G=(V,E), where V represents the set of vertices and E the set of edges connecting these vertices, the objective is to partition the set of vertices V into two disjoint subsets in such a way that the number of edges between the two subsets is maximized. Each edge in the graph has a weight, and the ‘cut’ of the partition refers to the sum of the weights of the edges that have endpoints in both subsets. The goal is to find the maximum cut, i.e., the partition that results in the highest sum of weights of the edges crossing the partition.

As shown in block 304, the method may segment, using the classical computing unit, the combinatorial optimization task into a plurality of sub-tasks. In the context of combinatorial optimization, the divide-and-conquer method may involve breaking down a complex optimization task into a series of smaller, more manageable sub-tasks. This method may be particularly effective for addressing large problems that may be challenging to solve in their entirety due to computational limitations or complexity. The primary combinatorial optimization task may be segmented into a plurality of sub-tasks, where each sub-task may be solved independently using a quantum computing unit, such as the quantum computing unit 202 shown in FIGS. 1B and 1C and described above. The criteria for segmenting the task may depend on its nature and complexity. For example, in graph-based problems like Max-Cut, the graph could be divided into smaller sub-graphs.

As shown in block 306, the method may, for each sub-task, access, using the classical computing unit, a database of pre-computed solutions to identify a pre-computed solution for the sub-task. Prior to solving each sub-task, the method may first determine whether the particular sub-task has a solution that is pre-computed using QAOA on the quantum computing unit (e.g., the quantum computing unit 202). As described herein, QAOA may be used to solve combinatorial optimization problems, such as the Max-Cut problem. QAOA operates on the principles of quantum mechanics, utilizing quantum bits (qubits) and quantum gates to encode and manipulate information. QAOA may be structured as a sequence of unitary transformations applied to a quantum state, with each transformation corresponding to elements of the optimization problem. In the context of the Max-Cut problem, QAOA may be used to find a partition of the graph that maximizes the number of edges between the two subsets of vertices. The quantum state's evolution may be tailored to reflect the structure of the Max-Cut problem, with the objective function encoded in a way that quantum states corresponding to better cuts have a higher probability of being observed upon measurement.

In some embodiments, the pre-computed solutions may be stored in the database along with relevant metadata, such as the parameters of the sub-task, the configuration of the quantum computing unit used, and the specific settings of the QAOA. In the context of the Max-Cut problem, the pre-computed solution may include a description of the sub-graph (e.g., the number of vertices and edges, graph structure, connectivity pattern, and/or the like), solution details (e.g., a bit string representing a partition of the vertices into two sets defining a cut through the graph), a cut value (e.g., the total weight of the edges crossing the partition), metadata (e.g., sub-task parameters, a quantum computing unit configuration, QAOA settings, and/or the like), performance metrics, and/or the like.

As shown in block 308, the method may, for each sub-task, determine whether a pre-computed solution has been identified. In some embodiments, the database of pre-computed solutions may be queried based on criteria derived from the characteristics of the current sub-task. These characteristics may include parameters such as the size of the sub-task, specific constraints, or other defining features.

As shown in block 310, in an instance in which a pre-computed solution has been identified, the method may retrieve, using the classical computing unit, the pre-computed solution from the database.

As shown in block 312, in an instance in which a pre-computed solution has not been identified, the method may transmit the sub-task from the classical computing unit to a quantum computing unit. Alternatively or additionally, the method may transmit the sub-task from the classical computing unit to other high-performance classical computing units such as GPUs or supercomputers that offer substantial computational power for complex problem solving. In some embodiments, prior to transmitting the sub-task from the classical computing unit to the quantum computing unit, the method may access the database of pre-computed solutions for an alternate pre-computed solution for the sub-task. The alternate pre-computed solution may be a pre-computed solution for an alternate sub-task that has a similar structure as the sub-task. In the context of a Max-Cut problem, the similarity in structure may be determined based on characteristics such as the number of vertices and edges, degree distribution, graph density, and/or other topological features. In an instance in which pre-computed solution or an alternate pre-computed solution is not found, the method may transmit the sub-task from the classical computing unit to the quantum computing unit to compute a solution for the sub-task using an optimization algorithm. In the context of the Max-Cut problem, the quantum computing unit may use QAOA to compute a solution for the sub-graph.

As shown in block 314, the method may compute, using the quantum computing unit, a solution for the sub-task using a quantum optimization algorithm. Computing a solution for a sub-task using the quantum optimization algorithm may involve leveraging the principles of quantum mechanics to find optimal solutions more efficiently than classical algorithms. In the context of the Max-Cut problem, to compute a solution, QAOA may be used to encode the sub-graph into a quantum compatible format (e.g., using the quantum program 204 described in FIG. 1A). Subsequently, a quantum circuit (e.g., the quantum circuit 212 described above in connection with FIG. 1C) may be designed to implement the QAOA. Next, the QAOA may be executed using the quantum circuit. In example embodiments, executing the QAOA may include applying a sequence of unitary operators corresponding to the problem parameterized by angles. The QAOA may iteratively adjust these parameters to find the combination that minimizes the energy of the quantum computing unit. After running the quantum circuit, the state of the qubits may be measured. Due to the probabilistic nature of quantum mechanics, this measurement may yield a solution that is one of the possible states of the quantum system. The probability of measuring the ground state (optimal solution) may be increased by correctly tuning the parameters of the QAOA. The measurement process may be repeated multiple times to obtain statistical confidence in the result. Once a satisfactory solution is obtained from the QAOA, the computed solution may be translated (e.g., using the quantum program 204 as described in connection with FIG. 1A) back into the context of the original sub-graph. Once transformed, as shown in block 316, the method may transmit the computed solution for the sub-task from the quantum computing unit to the classical computing unit. As new sub-tasks are solved, their solutions may be added to the database, continually expanding its utility.

As shown in block 318, the method may implement, using the classical computing unit, each pre-computed and computed solution on the combinatorial optimization task. In some embodiments, to implement the pre-computed solutions (in cases where a pre-computed solution exists in the database of pre-computed solutions) and the computed solutions (in cases where the quantum computing unit was used to compute the solution), the method may aggregate, using the classical computing unit, the pre-computed solution or the computed solution for each sub-task to generate a solution for the combinatorial optimization task. In embodiments where an alternate pre-computed solution is identified in the database of pre-computed solutions, the method may aggregate the pre-computed solution, the computed solution, or the alternate pre-computed solution for each sub-task for implementation. In some embodiments, the solutions (e.g., pre-computed, computed, and alternate pre-computed) may be aggregated and subsequently implemented on the combinatorial optimization task. In other embodiments, the solutions may be implemented on individual components of the combinatorial optimization task (e.g., the sub-tasks) and subsequently aggregated, culminating in a comprehensive solution for the combinatorial optimization task.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases the method may include additional steps. The steps and modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for enhanced combinatorial optimization, the method comprising:
receiving, at a classical computing unit, a combinatorial optimization task;
segmenting, using the classical computing unit, the combinatorial optimization task into a plurality of sub-tasks;
for each sub-task, accessing, using the classical computing unit, a database of pre-computed solutions to identify a pre-computed solution for the sub-task and, in an instance in which the pre-computed solution is not identified for the sub-task,
transmitting the sub-task from the classical computing unit to a quantum computing unit;
computing, using the quantum computing unit, a solution for the sub-task using a quantum optimization algorithm; and
transmitting the computed solution for the sub-task from the quantum computing unit to the classical computing unit; and
implementing, using the classical computing unit, each pre-computed and computed solution on the combinatorial optimization task.

2. The method of claim 1, wherein the method further comprises:
storing, using the classical computing unit, the computed solution in the database.

3. The method of claim 1, wherein the method further comprises, in an instance in which the pre-computed solution is identified for the sub-task:
retrieving, using the classical computing unit, the pre-computed solution from the database.

4. The method of claim 1, wherein implementing, using the classical computing unit, each pre-computed and computed solution on the combinatorial optimization task comprises:
aggregating, using the classical computing unit, the pre-computed solution and the computed solution for each sub-task to generate a solution for the combinatorial optimization task; and
implementing, using the classical computing unit, the solution on the combinatorial optimization task.

5. The method of claim 1, wherein the method further comprises, for each sub-task, in an instance in which the pre-computed solution for the sub-task is not identified:
accessing, using the classical computing unit, an alternate pre-computed solution, wherein the alternate pre-computed solution is a pre-computed solution for an alternate sub-task having similar structure as the sub-task,
wherein implementing, using the classical computing unit, each pre-computed and computed solution on the combinatorial optimization task comprises implementing each alternate pre-computed solution on the combinatorial optimization task.

6. The method of claim 1, wherein the combinatorial optimization task is a graph associated with a Max-Cut problem, and wherein each sub-task is a sub-graph.

7. The method of claim 1, wherein each pre-computed solution and computed solution is computed using an optimization algorithm.

8. The method of claim 7, wherein the optimization algorithm is a Quantum Approximate Optimization Algorithm (QAOA).

9. A system for enhanced combinatorial optimization, the system comprising:
a classical computing unit, the classical computing unit comprising:
a processing device; and
a non-transitory storage device containing instructions that, when executed by the processing device, cause the processing device to:
receive, from a computing device of a user, a combinatorial optimization task;
segment the combinatorial optimization task into a plurality of sub-tasks; and
for each sub-task, access a database of pre-computed solutions to identify a pre-computed solution for the sub-task; and
a quantum computing unit operatively coupled to the classical computing unit,
wherein, in an instance in which the pre-computed solution is not identified for the sub-task, the classical computing unit is configured to transmit the sub-task to the quantum computing unit for processing and the quantum computing unit is configured to:
compute a solution for the sub-task using a quantum optimization algorithm; and
transmit the computed solution to the classical computing unit, and
wherein the instructions, when executed by the processing device, cause the processing device to implement each pre-computed and computed solution on the combinatorial optimization task.

10. The system of claim 9, wherein the instructions, when executed, cause the processing device to:
store the computed solution in the database.

11. The system of claim 9, wherein, in an instance in which the pre-computed solution is identified for the sub-task, the instructions, when executed, cause the processing device to:
retrieve the pre-computed solution from the database.

12. The system of claim 9, wherein, the instructions, when executed to implement each pre-computed and computed solution on the combinatorial optimization task, cause the processing device to:
aggregate the pre-computed solution and the computed solution for each subtask to generate a solution for the combinatorial optimization task; and
implement the solution on the combinatorial optimization task.

13. The system of claim 9, wherein, for each sub-task, in an instance in which the pre-computed solution is not identified, the instructions, when executed, cause the processing device to:
access an alternate pre-computed solution, wherein the alternate pre-computed solution is a pre-computed solution for an alternate sub-task having similar structure as the sub-task,
wherein implementing each pre-computed and computed solution on the combinatorial optimization task comprises implementing each alternate pre-computed solution on the combinatorial optimization task.

14. The system of claim 9, wherein the combinatorial optimization task is a graph associated with a Max-Cut problem, and wherein each sub-task is a sub-graph.

15. The system of claim 9, wherein each pre-computed solution and computed solution is computed using an optimization algorithm.

16. The system of claim 15, wherein the optimization algorithm is a Quantum Approximate Optimization Algorithm (QAOA).

17. A computer program product for enhanced combinatorial optimization, the computer program product comprising a non-transitory computer-readable medium comprising code configured to cause an apparatus to:
receive, at a classical computing unit, a combinatorial optimization task;
segment, using the classical computing unit, the combinatorial optimization task into a plurality of sub-tasks;
for each sub-task, access, using the classical computing unit, a database of pre-computed solutions to identify a pre-computed solution for the sub-task and, in an instance in which the pre-computed solution is not identified for the sub-task,
transmitting the sub-task from the classical computing unit to a quantum computing unit;
computing, using the quantum computing unit, a solution for the sub-task using a quantum optimization algorithm; and
transmitting the computed solution for the sub-task from the quantum computing unit to the classical computing unit; and
implement, using the classical computing unit, each pre-computed and computed solution on the combinatorial optimization task.

18. The computer program product of claim 17, wherein the code further causes the apparatus to:
store, using the classical computing unit, the computed solution in the database.

19. The computer program product of claim 17, wherein, in an instance in which the corresponding pre-computed solution is identified for the sub-task, the code further causes the apparatus to:
retrieve, using the classical computing unit, the pre-computed solution from the database.

20. The computer program product of claim 17, wherein in implementing each pre-computed and computed solution on the combinatorial optimization task, the code further causes the apparatus to:
aggregate, using the classical computing unit, the pre-computed solution and the computed solution for each sub-task to generate a solution for the combinatorial optimization task; and
implement, using the classical computing unit, the solution on the combinatorial optimization task.

21. The computer program product of claim 17, wherein, for each sub-task, in an instance in which the corresponding pre-computed solution is not identified, the code further causes the apparatus to:
access, using the classical computing unit, an alternate pre-computed solution, wherein the alternate pre-computed solution is a pre-computed solution for an alternate sub-task having similar structure as the sub-task,
wherein implementing, using the classical computing unit, each pre-computed and computed solution on the combinatorial optimization task comprises implementing each alternate pre-computed solution on the combinatorial optimization task.

22. The computer program product of claim 17, wherein the combinatorial optimization task is a graph associated with a Max-Cut problem, and wherein each sub-task is a sub-graph.

23. The computer program product of claim 17, wherein each pre-computed solution and computed solution is computed using an optimization algorithm.

24. The computer program product of claim 23, wherein the optimization algorithm is a Quantum Approximate Optimization Algorithm (QAOA).
